(19) United States
(12) Patent Application Publication
(10) Pub. No.: US 2016/0012935 A1
(43) Pub. Date: Jan. 14, 2016

(54) FEEDSTOCKS FOR ADDITIVE MANUFACTURING AND METHODS FOR THEIR PREPARATION AND USE

(71) Applicant: Empire Technology Development LLC, Wilmington, DE (US)

(72) Inventor: Christopher J. Rothfuss, Laramie, WY (US)

(21) Appl. No.: 14/329,795

(22) Filed: Jul. 11, 2014

(51) Int. Cl. H01B 1/22; B29C 67/00; H01F 1/03; C09K 5/14; C08K 7/04; C04B 14/48

(52) U.S. Cl. CPC H01B 1/22; C08K 7/04; C04B 14/48; H01F 1/03; C09K 5/14; B29C 67/0051; B33Y 10/00

(57) ABSTRACT

A feedstock for additive manufacturing includes a matrix material, and one or more barbed fibers disposed within the matrix material. Each barbed fiber includes a central filament and one or more barbed structures configured to extend outwardly from the central filament after extrusion. Methods of making the feedstock and methods of using the feedstock to form three-dimensional objects are also disclosed.

### BACKGROUND

Additive manufacturing (AM) is a class of fabrication techniques that use a layer-by-layer construction approach to create complex three-dimensional shapes. Additive manufacturing processes are highly flexible and boast considerably higher material efficiencies than traditional subtractive manufacturing techniques. As a result, AM has been the subject of considerable innovation and research, resulting in a large variety of available processes and products. However, most current AM processes have been designed to use a relatively limited number of homogeneous materials, which can compromise the mechanical properties of the printed product. It will be desirable to provide feedstocks for AM that can result in improved mechanical properties of the printed articles. It will also be desirable if such feedstocks can be incorporated into existing AM processes.

### SUMMARY

The present disclosure is related, among other things, to reinforced feedstocks for extrusion-based additive manufacturing. The feedstock may include a matrix material; and one or more barbed fibers disposed within the matrix material, wherein each barbed fiber includes a central filament and the one or more barbed structures are configured to extend outwardly from the central filament after extrusion.

The present disclosure is also related to a method of fabricating a three-dimensional object. The method includes: providing a feedstock that includes a matrix material, and one or more barbed fibers disposed in the matrix material, wherein each barbed fiber includes a central filament and the one or more barbed structures configured to extend outwardly from the central filament after extrusion; extruding the feedstock through a nozzle of an additive manufacturing extruder, wherein the one or more barbed structures are in a non-extended state during the extruding; and depositing a layer of extruded feedstock onto a surface, wherein the one or more barbed structures extend outwardly from the central filament to an extended state after the extruding.

The present disclosure is further related to a three-dimensional object. The three-dimensional object may include one or more barbed fibers disposed within a matrix material, wherein each barbed fiber includes a central filament and one or more barbed structures extending outwardly from the central filament.

The present disclosure is also related to a method of making a feedstock. The method may include disposing one or more barbed fibers in a matrix material, wherein each barbed fiber comprises a central filament and one or more barbed structures configured to extend outwardly from the central filament after extrusion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a schematic diagram showing extrusion of a feedstock having barbed fibers disposed within a matrix material in accordance with the disclosed embodiments.

FIG. 2A shows a thread of feedstock having barbed structures biased in an extended state in accordance with the disclosed embodiments. FIG. 2B shows the feedstock of FIG. 2A in a non-extended state when passing through a nozzle of an additive manufacturing extruder, and in an extended state after exiting the extruder.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

### Feedstock for Additive Manufacturing

A feedstock for additive manufacturing is disclosed. The feedstock may include a matrix material, and one or more barbed fibers disposed within the matrix material. Each barbed fiber may include a central filament and one or more barbed structures configured to extend outwardly from the central filament after extrusion. The one or more barbed structures may, for example, extend outwardly in a radial fashion from the central filament. The matrix material may be configured to solidify after extrusion. Depending on the type of matrix material, the matrix material may be solidified for example by cooling, sintering chemical curing, and/or photocuring. In some embodiments, the one or more barbed structures are configured to extend outwardly from the central filament after extrusion and before the matrix material solidifies. The one or more barbed structures that are in the extended state can be configured to reinforce the matrix material. For example, the one or more barbed structures may form a scaffold within the matrix material when in the extended state to reinforce the matrix material.

The feedstock may include a single barbed fiber. The feedstock may include more than one barbed fiber, for example, a plurality of barbed fibers. In some embodiments, at least one of the one or more barbed fibers may include a central filament having at least two sections coupled longitudinally by a joining filament. The joining filament may have a diameter that is less than, substantially the same as, or greater than, a diameter of the at least two sections of the central filament. In some embodiments, the joining filament may have a diameter that is less than a diameter of the at least two sections of the central filament. The joining filament may or may not include barbed structures. In some embodiments, the joining filament does not include barbed structures. In some embodiments, at least one of the one or more barbed fibers includes sections of the central filament, each section having the one or more barbed structures extending from the central filament, and the sections are connected end-to-end with a thinner fiber connector (for example, a “nunchaku” geometry). The sections of the central filament may be linked via the joining filament in one continuous chain, or in separate discontinuous chains. In some embodiments, at least one of the one or more barbed fibers may include a central filament that is continuous and has a substantially uniform diameter.

The one or more barbed structures may be arranged in configurations that can impart reinforcement to the matrix material and yet achieve ease of extrusion. In some embodiments, the one or more barbed structures include caltrop-like structures. For example, the caltrop-like structures may be short pointed structures such as spikes, arranged along the central filament. The one or more barbed structures may be configured to be in a non-extended state during the extrusion to facilitate the extruding process. In some embodiments, the feedstock may include one or more barbed structures configured to substantially collapse against the central filament during extrusion. In some embodiments, the feedstock may include one or more barbed structures configured to substantially align longitudinally with the central filament during extrusion. The one or more barbed structures may be in the non-extended state or the extended state before extrusion or before the feedstock passes through a nozzle of an additive manufacturing extruder. For example, in embodiments where the one or more barbed structures are biased in the extended state, the barbed structures may be in the extended state before extrusion, compressed into the non-extended state during extrusion (for example, as the feedstock passes through the nozzle) and revert to the extended state after the extrusion (for example, after the feedstock exits the nozzle). In embodiments where the one or more barbed structures are configured to be responsive to a stimulus in order to transition from the non-extended state to the extended state, for example, barbed structures configured with magnetic properties that are responsive to an electromagnetic field (for example, a magnetic field), the barbed structures may be in the non-extended state before and during extrusion, and transitions to the extended state when exposed to the stimulus after the extrusion.

The feedstock may be configured to be compatible with an extrusion-based additive manufacturing process. In some embodiments, the feedstock may include a matrix material that is a polymer or two or more polymers. A wide variety of polymers can be applicable for the extrusion-based additive manufacturing process. In some embodiments, the matrix material includes at least one polymer selected from polycarbonate, acrylonitrile butadiene styrene, polycaprolactone, polyphenylsulfone, polyetherimide, or any combination thereof. The matrix material that includes one or more of these polymers may be solidified or cured, for example, by cooling chemical curing, and/or by photocuring (such as UV curing). In some embodiments, the matrix material includes a polycarbonate. In some embodiments, the matrix material includes acrylonitrile butadiene styrene. In some embodiments, the matrix material includes a blend of polycarbonate and acrylonitrile butadiene styrene. In some embodiments, the matrix material includes polycaprolactone. In some embodiments, the matrix material includes polyphenylsulfone. In some embodiments, the matrix material includes polyetherimide. The matrix material need not be limited to polymeric materials. Extrusion-based processes are capable of producing objects from pastes and slurries of a variety of ceramic materials. For example, slurries or pastes of ceramic materials may be extruded to form three dimensional printed objects. In some embodiments, the matrix material includes a ceramic paste, ceramic slurry, or both. In some embodiments, the matrix material includes zirconia, alumina, silica, graphite, or any combination thereof. In some embodiments, the matrix material includes zirconia. In some embodiments, the matrix material includes alumina. In some embodiments, the matrix material includes silica. In some embodiments, the matrix material includes graphite. Where the matrix material includes one or more of the ceramic materials as described herein, solidifying the matrix material may require heat treatment. For example, the deposited feedstock may be sintered to solidify the matrix material. In some embodiments, the feedstock, including the matrix material and the one or more barbed fibers, may be configured to withstand sintering at temperatures of at least about 1300° C. Concrete or cement are generally compatible with several large-scale additive manufacturing processes, and thus may also be used as a suitable matrix material. In some embodiments, the matrix material includes concrete, cement, or both. Curing or solidifying the concrete or cement may include methods known in the art such as allowing the concrete or cement to stand for a period of time until the material solidifies.

In some embodiments, the feedstock may further include one or more additives. The one or more additives can for example functionalize the matrix material. For example of the matrix material can be functionalized with properties such as electrical conductivity, thermal conductivity and/or magnetic property. In some embodiments, the one or more additives include at least one metal configured to provide one or both of electrical conductivity and thermal conductivity to the matrix material. Examples of suitable metals include copper, gold, aluminum, steel, silver, brass and carbon (for example, graphite). In some embodiments, the one or more additives include at least one magnetic material configured to impart a magnetic property to the central filament, the one or more barbed structures, or both. Suitable magnetic materials may include ferromagnetic materials such as iron. In some embodiments, the one or more additives are present in a coating on the central filament, a coating on the one or more barbed structures, or both. In some embodiments, the one or more additives are present in a bonding agent between the central filament, the barbed structures, or both, and the matrix material. For example, the central filament and/or the barbed structures can be coated with a bonding agent that includes polyvinyl acetate, polyacrylic acid, epoxy, and/or styrene butadiene rubber, to improve bonding between the central filament and/or the barbed structures, and the matrix material. In some embodiments, the one or more additives are doped into the one or more barbed structures, central filament and/or matrix material.

The one or more barbed structures may be configured with a magnetic property that is responsive to an electromagnetic field, for example, to enable the one or more structures to extend outwardly in response to the electromagnetic field. In some embodiments, each barbed structure has a magnetic property that is identifiable by an electromagnetic field such as a magnetic field. In some embodiments, the one or more barbed structures include a magnetic material. In some embodiments, the one or more barbed structures include a coating of magnetic material. In some embodiments, the one or more barbed structures include at least one magnetic particle. Suitable magnetic materials or particles may include ferromagnetic materials such as iron. Other than magnetic property, the one or more barbed structures may alternatively be configured to respond to other stimulus. In some embodiments, the one or more barbed structures include a shape memory material. The shape memory material may for example be nitinol. In some embodiments, the shape memory material is configured to be activated by exposure to heat to extend the barbed structures outwardly from the central filament. The shape memory material may alternatively be configured to be activated by exposure to an electromagnetic field.

### Method of Fabricating a Three Dimensional Object

A method of fabricating a three-dimensional object is also disclosed. The method includes: providing a feedstock that includes a matrix material and one or more barbed fibers disposed in the matrix material, wherein each barbed fiber includes a central filament and one or more barbed structures configured to extend outwardly from the central filament after extrusion; extruding the feedstock through a nozzle of an additive manufacturing extruder, wherein the one or more barbed structures are in a non-extended state during the extruding; depositing a layer of extruded feedstock onto a surface, wherein the one or more barbed structures extend outwardly from the central filament to an extended state after the extruding. As described above, the one or more barbed structures that are in the extended state can be configured to reinforce the matrix material, for example, by forming a scaffold within the matrix material. The method may further include allowing the matrix material to solidify, for example, by methods described above such as sintering, cooling, chemical curing and/or photocuring, depending on the type of matrix material.

To facilitate extrusion of the matrix material, the one or more barbed structures can be configured to be in a non-extended state before or during the extrusion. In some embodiments, when in the non-extended state, the one or more barbed structures are substantially collapsed against the central filament. In some embodiments, when in the non-extended state, the one or more barbed structures are substantially aligned longitudinally with the central filament.

In some embodiments, the depositing step includes depositing the layer of extruded feedstock in a pattern onto the surface. In some embodiments, the surface is a surface of a substrate, a surface of a three-dimensional object, or both. In some embodiments, the one or more barbed structures protrude beyond a surface of the matrix material when in the extended state.

In some embodiments, the method further includes repeating the extruding step and the depositing step one or more times to form one or more layers of the extruded feedstock. The one or more barbed structures may, in some embodiments, extend from one layer into an adjacent layer of the extruded feedstock when in the extended state. The extension of the one or more barbed structures between adjacent layers of the extruded feedstock can further reinforce interlayer bonding between the layers of feedstock, and/or mechanical strength of the resulting three-dimensional object.

The size, geometry and material composition of the barbed fiber (for example, including the one or more barbed structures and the central filament) are dependent upon the design requirements of the object being fabricated and the capabilities of the additive manufacturing machine. The material(s) that make up the barbed fiber are designed to be compatible with the additive manufacturing process used to extrude the feedstock. This compatibility includes a higher melting/glass transition temperature than the matrix material, a coefficient of thermal expansion that matches the matrix material, and/or a lack of chemical interaction with the matrix material. In some embodiments, the one or more barbed fibers are present in the feedstock in an amount selected to achieve a balance between reinforcement of the matrix material and ease of extrusion.

In some embodiments, the central filament and the barbed structures may be constructed from metal wires, including steel, aluminum, iron, copper, bronze, molybdenum, tungsten, titanium, or any combination thereof. In some embodiments, the central filament and the barbed structures may be constructed from fibers and whiskers of ceramics such as aramid (for example, KEVLAR®, from E.I. du Pont de Nemours and Company, Delaware, USA), glass, carbon, silicon carbide, aluminum oxide, silicon nitride, or any combination thereof. In some embodiments, the barbed structures may be constructed from liquid crystalline polymers, such as thermotropic liquid crystalline polymer (TLCP).

The dimensions of both the central filament and the barbed filament may vary based upon the application for which they are being used, since additive manufacturing ranges in scale from producing individual micromachines to printing entire building structures. The number of barbed structures attached to the central filament, the length of these barbed structures and their diameters can be designed to achieve an optimal balance between reinforcement of the matrix material and ease of extrusion through the nozzle. In some embodiments, one or more barbed structures are dimensioned to achieve a balance between reinforcement of the matrix material and ease of extrusion. For example, the length and/or diameter of the one or more barbed structures can be selected based on the thickness of each deposited layer of feedstock, size of the printed three-dimensional object, the size of the nozzle, or the type of matrix material, to achieve the balance. In some embodiments, the one or more barbed structures are arranged in a configuration selected to achieve a balance between reinforcement of the matrix material and ease of extrusion. For example, the one or more barbed structures may be configured to be in a non-extended state as described above during the extrusion, or arranged along the central filament such that the barbed structures form a scaffold when in the extended state that can multi-directionally reinforce the matrix material.

In some embodiments, the one or more barbed structures have substantially similar lengths. In some embodiments, the one or more barbed structures have different lengths from one another. In some embodiments, the one or more barbed structures have substantially similar diameters. In some embodiments, the one or more barbed structures have diameters different from one another.

In some embodiments, the additive manufacturing extruder is configured for use in one or more of fused deposition modeling, robocasting, 3D fiber deposition, precision extrusion deposition, multiphase jet solidification, contour crafting, low-temperature deposition modeling, fused deposition of multiple materials, and concrete printing.

In some embodiments, the one or more barbed structures deform from the non-extended state to the extended state in the presence of elastic potential energy, an electromagnetic field, thermal energy, or any combination thereof. In some embodiments, the one or more barbed structures deform from the non-extended state to the extended state upon in the presence of elastic potential energy stored in the barbed structures when in the non-extended state. For example, the barbed structures can be originally biased in an extended state and be deformed as they are forced through the nozzle. As the barbed structures leave the nozzle, the stored elastic potential energy is released, causing the barbed structures to self-extend outwardly. In some embodiments, the one or more barbed structures deform from the non-extended state to the extended state in the presence of an electromagnetic field. For example, the barbed structures may be formed from a magnetic material (for example, iron) and can be aligned longitudinally with the central filament in the non-extended state within the matrix material prior to and during the extruding. After the extruding, the barbed structures can extend outwardly from the central filament upon exposure to a magnetic field. In some embodiments, the one or more barbed structures deform from the non-extended state to the extended state in the presence of thermal energy. For example, the one or more barbed structures can be made of a shape memory material programmed to be responsive to heat.

In some embodiments, the method further includes extruding and depositing at least one additional layer of a second feedstock, the second feedstock including a second matrix material. The second matrix material may be any of the materials as described above for the matrix material, and can be configured to solidify after extrusion using methods as described above for the matrix material. In some embodiments, the second matrix material in the at least one additional layer of the second feedstock is configured to interface with one or more barbed structures that protrude beyond an underlying layer of matrix material. In some embodiments, the second matrix material can have a viscosity selected to promote interfacing with the one or more barbed structures that protrude beyond an underlying layer of matrix material. For example, the viscosity of the matrix material before solidifying may not be too viscous such that the material cannot flow over the protruding barbed structures, and may not be too runny such that the material cannot engage the protruding barbed structures. In some embodiments, the second feedstock further includes one or more second barbed fibers disposed in the second matrix material, wherein each second barbed fiber includes a second central filament and one or more second barbed structures configured to extend outwardly from the second central filament after extrusion. In some embodiments, one or more second barbed structures are configured to extend outwardly from the second central filament after extrusion and before the second matrix material solidifies. In some embodiments, the one or more second barbed structures in the second matrix material are configured to interact with the one or more barbed structures in an underlying layer of matrix material, for example, by engagement with one another to strengthen the bonding of the second matrix material to the underlying layer of matrix material. In some embodiments, the second matrix material is different from or the same as the matrix material in an underlying layer of feedstock. In some embodiments, the one or more second barbed fibers are different from or the same as the one or more barbed fibers in an underlying layer of feedstock. In some embodiments, the second matrix material is chemically inert to the matrix material in an underlying layer of feedstock. In some embodiments, the second matrix material and the matrix material have substantially similar melting points. In some embodiments, the second matrix material and the matrix material have substantially similar coefficients of thermal expansion.

In some embodiments, the method further includes extruding and depositing a final layer including a third matrix material, wherein any barbed structures protruding from any underlying layers of matrix material are encapsulated by the final layer. The third matrix material may be any of the materials as described above for the matrix material and the second matrix material, and can be configured to solidify after extrusion using methods as described above for the matrix material and the second matrix material. In some embodiments, the final layer may not include barbed fibers in the third matrix material. In some embodiments, the third matrix material is configured to encapsulate any protruding barbed structures from an underlying matrix layer or second matrix layer to smoothen an outer surface of the three-dimensional object.

A three-dimensional object is also disclosed. The three-dimensional object includes: one or more barbed fibers disposed within a matrix material, wherein each barbed fiber includes a central filament and one or more barbed structures extending outwardly from the central filament. The matrix material can be a solid material. The three dimensional object can be fabricated from the methods as described above. In some embodiments, the three-dimensional object includes at least one layer of feedstock that includes the matrix material and the barbed fiber, and one layer of feedstock that includes the matrix material without the barbed fiber. For example, the three-dimensional object may include alternative layers of the feedstock with barbed fiber and the feedstock without barbed fiber. In another example, the three-dimensional object may include at least two layers of feedstocks having the barbed fiber.

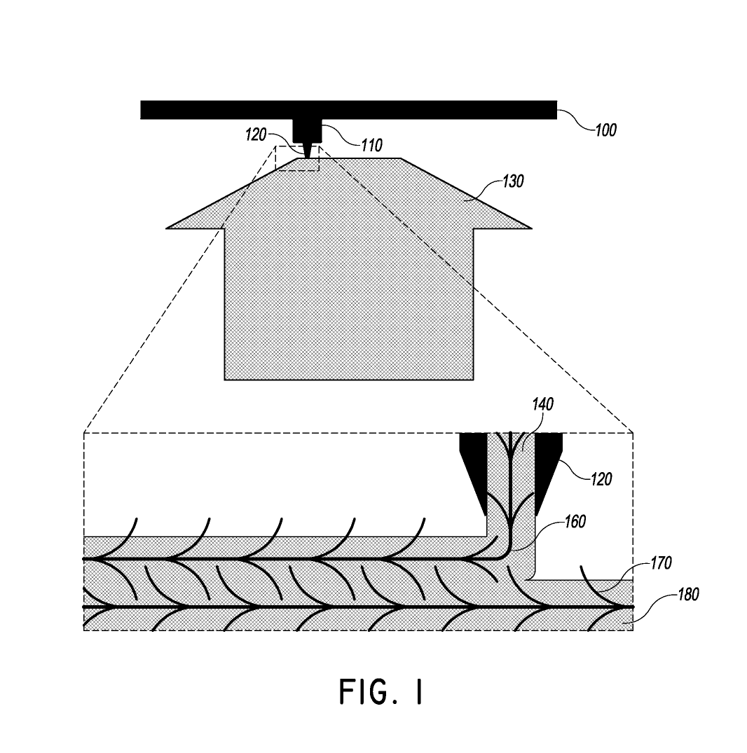

FIG. 1 shows an example embodiment of extruding a feedstock having barbed fibers disposed within a matrix material. At least one barbed fiber having a central filament 160 with barbed structures 170 is added to the matrix material 180 to form the feedstock 140 for an extrusion-based AM process. The additive manufacturing extruder 100 has an extrusion head 110 and extrusion nozzle 120 and can be used to create a three dimensional object 130. The barbed structures 170 are initially in a non-extended state such that the barbed structures are substantially collapsed against the central filament 160 to allow for easy movement through the extrusion nozzle 120. The barbed structures 170 expand outwards from the central filament 160 upon deposition of the feedstock 140, creating a three-dimensional scaffold that doubles as a reinforcement for the matrix material 180 and an improved surface for depositing the next layer of feedstock 140.

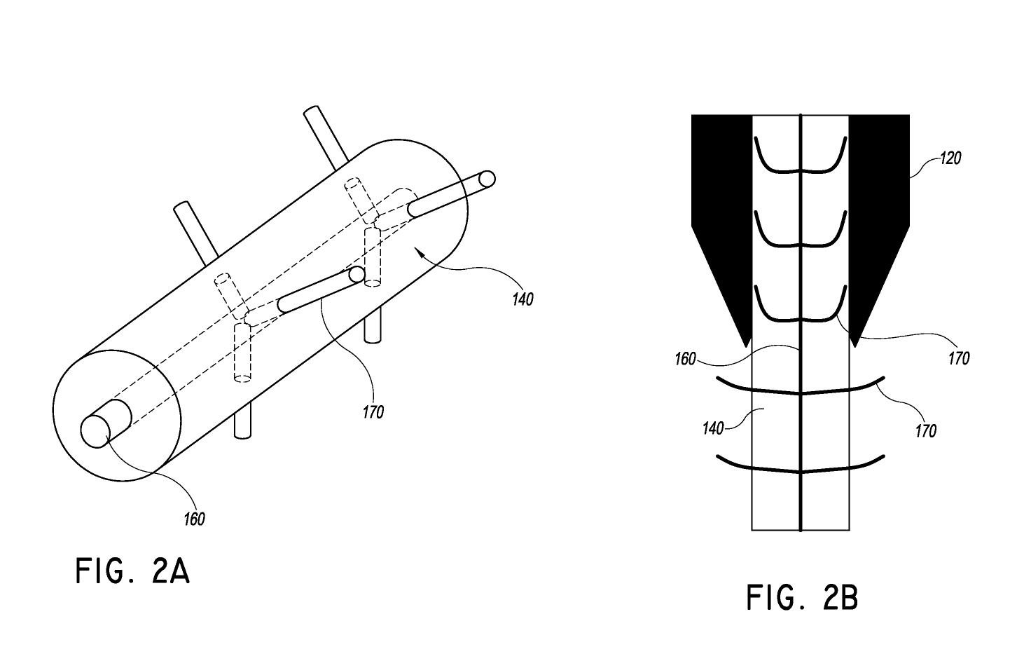

FIG. 2A shows an example thread of feedstock 140 having a barbed fiber in a matrix material. The barbed fiber has barbed structures 170 biased in an extended state, such that the barbed structures 170 extend outwardly from a central filament 160. FIG. 2B shows the thread of feedstock 140 passing through an additive manufacturing extruder 100. The barbed structures 170 are spring-like and are designed such that the extended configuration is an original or natural state. During passage of the feedstock 140 through the extruder 100, the spring-like barbed structures 170 are compressed towards the central filament in the nozzle 120. Once the barbed structures 170 have cleared the end of the nozzle 120, the compressed barbed structures 170 extend outwards until they have returned to the original extended configuration, in a manner analogous to releasing a compressed spring. The barbed structures 170 may protrude from a surface of the deposited feedstock before the matrix material has solidified. The protruded barbed structures 170 can embed themselves in the next layer of deposited feedstock.

### Method of Making a Feedstock for Additive Manufacturing

A method of making a feedstock is also disclosed. The method includes disposing one or more barbed fibers in a matrix material, wherein each barbed fiber includes a central filament and one or more barbed structures configured to extend outwardly from the central filament after extrusion. The one or more barbed structures can be configured to be in a non-extended state during the extrusion. In some embodiments, the one or more barbed structures are substantially collapsed against the central filament when in the non-extended state. In some embodiments, the one or more barbed structures are substantially aligned longitudinally with the central filament when in the non-extended state. In some embodiments, the one or more barbed structures are configured to extend outwardly from the central filament after extrusion and before the matrix material solidifies. The barbed fibers, central filament, barbed structures and matrix material can be as described above.

The one or more barbed fibers can be disposed in the matrix material before being fed into the extruder, or in the extruder. In some embodiments, the one or more barbed fibers are disposed in the matrix material before the matrix material is fed into an additive manufacturing extruder. For example, the barbed fiber can be pre-mixed into the matrix material. In another example, a molten polymer may be poured into a cylindrical mold that contains the barbed fiber, and the polymer is then allowed to cool forming a rod of solid polymer with the barbed fiber inside of it. This rod may be used as a feedstock. In some embodiments, the one or more barbed fibers and the matrix material are fed into the additive manufacturing extruder simultaneously. In some embodiments, the one or more barbed fibers are disposed in the matrix material after the matrix material is fed into an additive manufacturing extruder. In some embodiments, the one or more barbed fibers and the matrix material are fed into the additive manufacturing extruder separately. For example, the barbed fiber and the matrix material can be fed separately into the additive manufacturing apparatus, allowed to mix (for example, in the nozzle), and then extruded. Other methods known in the art for incorporating fibrous materials into a matrix material may also be applicable.

The feedstock can be of a consistency that can be easily extruded from the nozzle. In some embodiments, the feedstock is a fluid. For example, the matrix material may be a fluid in a liquid or semi-liquid state, such as a molten thermoplastic polymer, an uncured thermosetting polymer, a ceramic slurry/paste, unset concrete, and so on.

The method may further include adding one or more additives to the feedstock as described above. For example, incorporating metals and/or magnetic materials as described into a coating formed on the central filament and/or barbed structures, incorporating metals and/or magnetic materials as described into a bonding agent between the barbed fibers (include the central filament and the barbed structures) and the matrix material, or incorporating metals and/or magnetic materials as described by doping the materials into the barbed structures, central filament and/or matrix material.

### Comparative Benefits and Advantages

The feedstock of the disclosed embodiments can provide three-dimensional fibrous structures within the matrix material to improve bonding between material layers and to provide reinforcement to the matrix material along multiple axes.

Composite materials in general function by transferring a portion of applied loads from the matrix material, which is relatively weak, to the embedded reinforcements, which are made from a stronger material. The effectiveness of the reinforcements is therefore governed by both the mechanical properties of the reinforcements and the ability of the matrix to transfer the load to them. In the case of fiber-reinforced composites, the alignment of the fibers within the matrix and the direction of the applied load are crucial to the latter criteria. The effective modulus of elasticity for an aligned fiber composite in the fiber direction is given by

E_{ct}=EₘVₘ+E_{f}V_{f} (1)

where E_{ct} is the elastic modulus of the composite in the longitudinal direction, Eₘ and E_{f} are the elastic moduli of the matrix and fiber, respectively, and Vₘ and V_{f} are the volume fractions of the matrix and fiber, respectively. Similarly, the transverse elastic modulus for an aligned fiber composite is calculated using Equation 2:

$${E}_{ct} = \frac{{E}_{m} {E}_{f}}{{E}_{f} {V}_{m} + {E}_{m} {V}_{f}} \qquad ( 2 )$$

where E_{ct} is the elastic modulus in the transverse direction. For composites with randomly-oriented fibers, the equation for the composite elastic modulus is given by

E_{cd}=KEₘVₘ+E_{f}V_{f} (3)

where K is the reinforcement efficiency of the fibers and E_{cd} is the elastic modulus of the composite from any load direction. For a composite with fibers randomly oriented through a three-dimensional space, the reinforcement efficiency is assumed to be ⅕.

In applying the above equations to composites formed using the feedstock of the disclosed embodiments, the longitudinal elastic modulus of the composite may be calculated using Equation (1) above. For example, assuming a fiber volume fraction, V_{f}, of 20%, a fiber elastic modulus, E_{f}, of 69 GPa and a matrix elastic modulus, Eₘ, of 2.3 GPa, the longitudinal elastic modulus of the composite will be about 15.64 GPa. The elastic modulus in the transverse direction can be calculated using Equation (3), assuming a reinforcement efficiency, K, of ⅕ and the modulus values described above. The transverse elastic modulus will be about 4.60 GPa. Suitable volume fractions of material will vary based upon the properties of the materials used and the design specifications of the manufactured object. A good general range is between 50 vol % and 95 vol % matrix material in the mixture. A narrower range, if desired, may be between 70 vol % and 95 vol % matrix.

In comparison, for a composite made with the same matrix material but using fibers that do not have barbed structures, the longitudinal elastic modulus can be similar but the transverse elastic modulus will be greatly reduced to about 2.85 GPa (calculated using Equation 3).

There is a considerable disparity between the elastic moduli in the longitudinal and transverse directions for fiber reinforced composites with reinforcing fibers aligned in one direction, usually the longitudinal direction. Aligning the fibers within the matrix material in such a manner produces excellent strengthening in the longitudinal direction but does very little to assist with loads in the transverse directions. On the other hand, using randomly oriented fiber segments improves the transverse properties of the composite, but also reduces longitudinal reinforcement and results in lower reinforcement efficiency. These issues are particularly pronounced in composites formed using extrusion-based additive manufacturing processes, since the requirement of fitting the fibers through the nozzle of the extruder puts a limit on the number of possible fiber orientations within the matrix. Accordingly, conventional additive manufacturing-produced fiber-reinforced composites tend to perform poorly when loaded in transverse directions.

The barbed fiber reinforced feedstock disclosed herein remedies this shortcoming by adding at least one reinforcing barbed fiber to the matrix material of each feedstock thread, and the barbed fiber extends in both longitudinal and transverse directions. The central filament of the barbed fiber is aligned with the deposited feedstock thread, and thus provides longitudinal support to the matrix material. Each barbed structure extending outwardly from the central filament, aligns itself in a different transverse direction before the matrix material solidifies around it, producing reinforcement in the transverse direction without compromising on longitudinal integrity. Also, the barbed structures of the barbed fibers in a feedstock thread are capable of overlapping and intertwining with the barbed structures of the barbed fibers in an adjacent deposited thread of feedstock material, creating the opportunity for additional transverse support.

In addition to its role as a reinforcement for the matrix material, the barbed fiber disclosed herein has multiple other unique benefits and advantages. The protruding barbed structures outside the surface of the deposited matrix material improve the mechanical bonding between material layers by penetrating and anchoring each successive layer as it is deposited. Similarly, the barbed fiber reinforcement facilitates the strong bonding of different material types by providing an interconnecting fiber structure for the second material to attach to. The barbed fiber reinforcement is also producible with commodity additive manufacturing materials and reinforcement materials, which minimizes the amount of research and development required to apply the barbed fiber material in existing additive manufacturing processes.

The feedstocks of the disclosed embodiments use widely available matrix materials, such as polycarbonate and aluminum, which makes them simple and relatively inexpensive to implement. Thus, it is relatively easy to incorporate the disclosed reinforced feedstocks and methods of using the feedstocks into existing extrusion-based additive manufacturing processes, and minimal further innovation and development would be required to make it market-ready. Additionally, applications of the feedstocks can be highly flexible and easily scalable for printing objects of different sizes, ranging from handheld objects to construction-scale structures.

### EXAMPLES

### Example 1

### Layering Feedstocks of Dissimilar Polymer Matrices Having Barbed Structures Made of a Shape Memory Material (Nitinol) that is Responsive to Heat

This example describes reinforcing the bond between a first layer and a second layer of different thermoplastic polymer matrix materials with nitinol barbed structures.

A barbed fiber, including a central aluminum filament and multiple sets of four radial nitinol barbed structures is inserted into a mold. The barbed structures are collapsed against the central filament in the non-extended state. The diameter of the central filament is 2 mm, and the diameter of the mold (and also the print head of a fused deposition modeling apparatus) is 12 mm. The diameter of each radial barbed structure is 1 mm. Molten polycarbonate is added to the mold containing the barbed fiber until the mold is completely filled, and allowed to solidify by cooling to room temperature. The resulting feedstock includes about 70 vol % to about 95 vol % polycarbonate as the polymer matrix material. The feedstock is fed directly into the print head of the fused deposition modeling (FDM) apparatus and then extruded.

Upon heating to 260° C., the feedstock becomes soft enough (a semi-liquid state) to permit forcing through the nozzle of the FDM apparatus. The heat also causes the nitinol barbed structures to extend outwardly from the central filament after exiting the nozzle. The polymer matrix material is allowed to solidify by cooling to room temperature with the barbed structures in the extended state to form a first material layer. The barbed structures extend beyond the surface of the first layer.

Molten polyphenylsulfone is then deposited atop the first layer until the barb structures protruding from the surface is completely covered. The second matrix material (polyphenylsulfone) is allowed to solidify by cooling to room temperature to form a second layer. The bond between the first and second layer can be reinforced by the barbed structures that infiltrated both layers.

This example teaches that the bonding of two matrix materials of dissimilar materials may be strengthened using barbed fibers having barbed structures made of shape memory material (nitinol).

### Example 2

### Layering Feedstocks of Similar Polymer Matrices Having Barbed Structures that Extend in the Presence of Elastic Potential Energy

This example describes reinforcing the bond between a first layer and a second layer of extruded acrylonitrile butadiene styrene (ABS) with aluminum barbed structures.

A barbed fiber, including a central aluminum filament and five sets of four radial aluminum barbed structures is inserted into a mold. The barbed structures are spring-like structures that are biased in an extended state (extended away from the central filament). The diameter of the central filament is 3 mm, and the diameter of the mold (and also the print head of the FDM apparatus) is 10 mm. The diameter of each radial barbed structure is 2 mm. Molten ABS is added to the mold containing the barbed fiber until the mold is completely filled, and allowed to solidify by cooling to room temperature. The resulting feedstock includes about 70 vol % to about 95 vol % ABS as the polymer matrix material. The feedstock is fed directly into the print head of the FDM apparatus and extruded.

As the feedstock is extruded, the barbed structures are compressed by the walls of the nozzle to collapse against the central filament (non-extended state). As the feedstock exits the nozzle, the elastic potential energy that is stored in the compressed barbed structures is released, causing them to extend outwardly from the central filament (extended state). The polymer matrix material is allowed to solidify by cooling to room temperature with the barbed structures in the extended state to form a first material layer. The barbed structures extend beyond the surface of the first layer.

Additional ABS polymer is then deposited atop the first layer until the barb structures protruding from the surface is completely covered. The second matrix material (ABS polymer) is allowed to solidify by cooling to room temperature to form a second layer. The bond between the first and second layer can be reinforced by the barbed structures that infiltrated both layers.

This example teaches that the bonding of two matrix materials of similar materials may be strengthened using barbed fibers having barbed structures configured with spring-like properties.

### Example 3

### Layering Feedstocks of Similar Polymer Matrices Having Barbed Structures Made of a Shape Memory Material (Nitinol) that is Responsive to Heat

This example describes reinforcing the bond between a first layer and a second layer of extruded polycarbonate matrix with nitinol barbed structures.

A barbed filament, including a central aluminum filament and four sets of four radial nitinol barbed structures is inserted into a mold. The barbed structures are collapsed against the central filament in the non-extended state. The diameter of the central filament is 2 mm, and the diameter of the mold (and also the print head of a fused deposition modeling apparatus) is 12 mm. The diameter of each radial barbed structure is 1 mm. Molten polycarbonate is added to the mold containing the barbed fiber until the mold is completely filled, and allowed to solidify by cooling to room temperature. The resulting feedstock includes about 70 vol % to about 95 vol % polycarbonate matrix material. The feedstock is fed directly into the print head of the fused deposition modeling (FDM) apparatus and extruded.

Upon heating to 260° C., the feedstock becomes soft enough (a semi-liquid state) to permit forcing through the nozzle of the FDM apparatus. The heat also causes the nitinol barbed structures to extend outwardly from the central filament after exiting the nozzle. The matrix material is allowed to solidify by cooling to room temperature with the barbed structures in the extended state to form a first material layer. The barbed structures extend beyond the surface of the first layer.

Molten polycarbonate is then deposited atop the first layer until the barb structures protruding from the surface is completely covered. The second matrix material (polycarbonate) is allowed to solidify to form a second layer. The bond between the first and second layer can be reinforced by the barbed structures that infiltrated both layers.

This example teaches that nitinol barbed structures may be used to strengthen the bond between a first and second layer of similar matrix materials.

### Example 4

### Layering Feedstocks of Similar Polymer Matrices Having Magnetic Barbed Structures

This example describes reinforcing the bond between a first layer and a second layer of extruded polyphenylsulfone matrix with iron barbed structures.

A barbed fiber, including a central aluminum filament and nine sets of four radial iron barbed structures is inserted into a mold. The barbed structures are collapsed against the central filament in a non-extended state. The diameter of the central filament is 4 mm, and the diameter of the mold (and also the print head of the FDM apparatus) is 12 mm. The diameter of each radial barbed structure is 3 mm. Molten polyphenylsulfone is added to the mold containing the barbed fiber until the mold is completely filled, and allowed to solidify by cooling to room temperature. The resulting feedstock includes about 70 vol % to about 95 vol % polyphenylsulfone as the polymer matrix material. The feedstock is fed directly into the print head of the FDM apparatus and extruded.

Upon heating to 260° C., the feedstock becomes soft enough (a semi-liquid state) to permit forcing through the nozzle of the FDM apparatus. The extruded feedstock is exposed to an electromagnetic field after exiting the nozzle. An electromagnet is placed near the deposited feedstock while it is still in a semi-liquid state, and the electromagnet is activated. The strength of the applied magnetic field can be adjusted based on the magnetic properties of the barbed structures, and the viscosity of the matrix material. The electromagnetic field causes the iron barbed structures to extend outwardly from the central filament after exiting the nozzle. The matrix material is allowed to solidify by cooling to room temperature with the barbed structures in the extended state to form a first material layer. The iron barbed structures extend beyond the surface of the first layer.

Additional polyphenylsulfone is then deposited atop the first layer until the barb structures protruding from the surface is completely covered. The second matrix material (polyphenylsulfone) is allowed to solidify by cooling to room temperature to form a second layer. The bond between the first and second layer can be reinforced by the barbed structures that infiltrated both layers.

This example teaches that the bonding of two matrix materials of similar materials may be strengthened using barbed fibers having barbed structures configured with magnetic properties.

### Example 5

### Layering Feedstocks of Dissimilar Polymer Matrices Having Barbed Structures that Extend in the Presence of Elastic Potential Energy

This example describes reinforcing the bond between a first layer of extruded acrylonitrile butadiene styrene (ABS) and a second layer of extruded polycarbonate, both with aluminum barbed structures.

A barbed fiber, including a central aluminum filament and ten sets of four radial aluminum barbed structures is inserted into a mold. The barbed structures are spring-like structures that are biased in an extended state (extended away from the central filament). The diameter of the central filament is 3 mm, and the diameter of the mold (and also the print head of the FDM apparatus) is 10 mm. The diameter of each radial barbed structure is 2 mm. Molten ABS is added to the mold containing the barbed fiber until the mold is completely filled, and allowed to solidify by cooling to room temperature. The resulting feedstock includes about 70 vol % to about 95 vol % ABS as the polymer matrix material. The feedstock is fed directly into the print head of the FDM apparatus and extruded.

As the feedstock is extruded, the elastic potential energy that is stored in the compressed barbed structures is released, causing them to extend outwardly from the central filament. The polymer matrix material is allowed to solidify by cooling to room temperature with the barbed structures in the extended state to form a first material layer. The barbed structures extend beyond the surface of the first layer.

Molten polycarbonate is then deposited atop the first layer until the barb structures protruding from the surface is completely covered. The second matrix material (polycarbonate) is allowed to solidify by cooling to room temperature to form a second layer. The bond between the first and second layer can be reinforced by the barbed structures that infiltrated both layers.

This example teaches that the bonding of two matrix materials of dissimilar materials may be strengthened using barbed fibers having barbed structures configured with spring-like properties.

### Example 6

### Electrically and Thermally Conductive Feedstock

This example describes an electrically and thermally conductive feedstock.

A copper-coated barbed fiber, including a central aluminum filament and three sets of four radial aluminum barbed structures, is inserted into a mold. The diameter of the central filament is 2 mm, and the diameter of the mold (and also the print head of the FDM apparatus) is 8 mm. The diameter of each of the radial barbed structures is 1 mm. Molten polycaprolactone is added to the mold containing the barbed fiber until the mold is completely filled, and allowed to solidify by cooling to room temperature. The resulting feedstock includes about 70 vol % to about 95 vol % polycaprolactone as the polymer matrix material. The feedstock is fed directly into the print head of the FDM apparatus and extruded to form printed composites.

The copper coating can functionalize the matrix material such that it forms a printed composite having electrical and thermal conductivities. By incorporating such properties, the composite material can have broader ranges of use. For example, the conductive composites can be useful as heat sinks, thermal interface materials, electrical interconnections, and electronic packaging components.

This example teaches that a copper coating may be used to functionalize a polymer matrix material with electrical and thermal conductive properties.

### Example 7

### Feedstock with Ceramic Paste Matrix Material

This example describes a feedstock with a ceramic paste matrix.

A barbed fiber, including a central aluminum filament and six sets of four radial aluminum barbed structures, is inserted into a mold. The diameter of the central filament is 5 mm, and the diameter of the mold (and also the print head of the FDM apparatus) is 15 mm. The diameter of each of the radial barbed structure is 3 mm.

A silica paste is created by pulverizing bulk zirconia into a fine powder, and mixing the powder into water until the slurry reaches a desirable consistency using an industrial mixing device to form a paste (for example, a cement mixer) before introducing it to the FDM apparatus. The paste is added to the mold containing the barbed fiber until the mold is completely filled. The resulting feedstock includes about 70 vol % to about 95 vol % of silica paste. The feedstock is fed directly into the print head of the FDM apparatus and extruded. The deposited ceramic slurry is deposited onto a “green part,” and then sintered to form a solid. The finished ceramic is glazed. The barbed fiber can reduce the overall brittleness of the ceramic solid and improve tensile strength.

This example teaches that a ceramic material may be used as a feedstock for additive manufacturing, and by incorporating barbed fibers in the feedstock, material properties of the formed object can be improved.

### Example 8

### Method of Making a 3-D Object Using Feedstock from Example 2

This example describes reinforcing the bond between a first layer and a second layer of extruded acrylonitrile butadiene styrene (ABS) with aluminum barbed structures.

The feedstock prepared in Example 2 is fed directly into the print head of a fused deposition modeling apparatus and extruded.

As the feedstock is extruded, the elastic potential energy that is stored in the compressed barbed structures is released, causing them to extend outwardly from the central filament. The matrix material is allowed to solidify with the barbed structures in the extended state by cooling to room temperature to form a first material layer. The barbed structures extend beyond the surface of the first layer.

Additional ABS polymer is then deposited atop the first layer until the barb structures protruding from the surface is completely covered. The second matrix material (ABS polymer) is allowed to solidify by cooling to room temperature to form a second layer. The bond between the first and second layer can be reinforced by the barbed structures that infiltrate both layers.

Additional feedstock is extruded in the same manner described above to form additional layers until the 3-D object is completed. The layers alternated between one layer that contains aluminum barbed structures, and one layer that does not contain aluminum barbed structures.

This example teaches that layers in a three-dimensional object may be strengthened using barbed fibers having barbed structures configured with spring-like properties.

### Example 9

### Method of Making a 3-D Object Using Feedstock from Example 3

This example describes reinforcing the bond between a first and second layer of extruded polycarbonate matrix with nitinol barbed structures.

The feedstock prepared in Example 3 is fed directly into the print head of a fused deposition modeling apparatus and extruded.

Upon heating to 260° C., the feedstock becomes soft enough (a semi-liquid state) to permit forcing through the nozzle of the FDM apparatus. The heat also causes the nitinol barbed structures to extend outwardly from the central filament after exiting the nozzle. The matrix material is allowed to solidify by cooling to room temperature with the barbed structures in the extended state to form a first material layer. The barbed structures extend beyond the surface of the first layer.

Molten polycarbonate is then deposited atop the first layer until the barb structures protruding from the surface had been completely covered. The second matrix material (polycarbonate) is allowed to solidify to form a second layer. The bond between the first and second layer can be reinforced by the barbed structures that infiltrate both layers.

Additional feedstock is extruded in the same manner described above to form additional layers until the 3-D object is completed. The layers alternated between one layer that contains nitinol barbed structures and one layer that does not contain nitinol barbed structures.

This example teaches that layers in a three-dimensional object may strengthened by using barbed fibers having nitinol barbed structures.

### Example 10

### Method of Making a 3-D Object Using Feedstock from Example 4

This example describes reinforcing the bond between a first and second layer of extruded polyphenylsulfone matrix with iron barbed structures.

The feedstock prepared in Example 4 is fed directly into the print head of a fused deposition modeling (FDM) apparatus and extruded.

Upon heating to 260° C., the feedstock becomes soft enough (a semi-liquid state) to permit forcing through the nozzle of the FDM apparatus. The extruded feedstock is exposed to an electromagnetic field after exiting the nozzle. An electromagnet is placed near the deposited feedstock while it is still in a semi-liquid state, and the electromagnet is activated. The strength of the applied magnetic field can be adjusted based on the magnetic properties of the barbed structures, and the viscosity of the matrix material. The electromagnetic field causes the iron barbed structures to extend outwardly from the central filament after exiting the nozzle. The matrix material is allowed to solidify by cooling to room temperature with the barbed structures in the extended state to form a first material layer. The iron barbed structures extend beyond the surface of the first layer.

Additional polyphenylsulfone is then deposited atop the first layer until the barbs protruding from the surface is completely covered. The second matrix material (polyphenylsulfone) is allowed to solidify by cooling to room temperature to form a second layer. The bond between the first and second layer can be reinforced by the barbed structures that infiltrate both layers.

Additional feedstock is extruded in the same manner described above to form additional layers until the 3-D object is completed. The layers alternated between containing a layer that contains iron barbed structures and a layer that does not contain iron barbed structures.

This example teaches that layers in a three-dimensional object may be strengthened by barbed fibers having barbed structures configured with magnetic properties.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A feedstock for additive manufacturing, the feedstock comprising:
a matrix material; and
one or more barbed fibers disposed within the matrix material,
wherein each barbed fiber comprises a central filament and one or more barbed structures configured to extend outwardly from the central filament after extrusion.

2. The feedstock of claim 1, wherein the one or more barbed structures are configured to extend outwardly from the central filament after the extrusion and before the matrix material solidifies.

3. The feedstock of claim 1, wherein the one or more barbed structures are configured to substantially collapse against the central filament during the extrusion.

4. The feedstock of claim 1, wherein the matrix material comprises polycarbonate, acrylonitrile butadiene styrene, polycaprolactone, polyphenylsulfone, polyetherimide, or any combination thereof.

5. The feedstock of claim 1, wherein the matrix material comprises a ceramic paste, ceramic slurry, or both.

6. The feedstock of claim 1, wherein the matrix material comprises concrete, cement, or both.

7. The feedstock of claim 1, further comprising one or more additives.

8. The feedstock of claim 7, wherein the one or more additives comprise at least one metal configured to provide one or both of electrical conductivity and thermal conductivity to the matrix material.

9. The feedstock of claim 7, wherein the one or more additives comprise a magnetic material configured to impart a magnetic property to the central filament, the barbed structures, or both.

10. The feedstock of claim 1, wherein the one or more barbed structures comprise a magnetic material.

11. The feedstock of claim 10, wherein each barbed structure is configured to have a magnetic property that is identifiable by an electromagnetic field.

12. The feedstock of claim 1, wherein the one or more barbed structures comprise a shape memory material.

13. The feedstock of claim 12, wherein the shape memory material is configured to be activated by exposure to heat, to an electromagnetic field, or both, to extend the barbed structures outwardly from the central filament.

14. A method of fabricating a three-dimensional object, the method comprising:
providing a feedstock comprising a matrix material, and one or more barbed fibers disposed in the matrix material, wherein each barbed fiber comprises a central filament and one or more barbed structures configured to extend outwardly from the central filament after extrusion;
extruding the feedstock through a nozzle of an additive manufacturing extruder, wherein the one or more barbed fibers are in a non-extended state during the extruding; and
depositing a layer of extruded feedstock onto a surface, wherein the one or more barbed structures extend outwardly from the central filament to an extended state after the extruding.

15. The method of claim 14, wherein the extended state of the one or more barbed structures reinforces the matrix material.

16. The method of claim 14, further comprising:
allowing the matrix material to solidify.

17. The method of claim 14, wherein the one or more barbed structures protrude beyond a surface of the matrix material when in the extended state.

18. The method of claim 14, further comprising repeating the extruding step and the depositing step one or more times to form one or more additional layers of the extruded feedstock.

19. The method of claim 18, wherein the one or more barbed structures extend from one layer into an adjacent layer when in the extended state

20. The method of claim 14, wherein the one or more barbed structures deform from the non-extended state to the extended state in the presence of elastic potential energy, an electromagnetic field, thermal energy, or a combination thereof.

21. The method of claim 14, further comprising extruding and depositing at least one additional layer of a second feedstock, the second feedstock comprising a second matrix material.

22. The method of claim 21, wherein the second feedstock further comprises one or more second barbed fibers disposed in the second matrix material, wherein each second barbed fiber comprises a second central filament and one or more second barbed structures configured to extend outwardly from the second central filament after extrusion.

23. The method of claim 22, wherein the one or more second barbed structures in the second matrix material are configured to interact with the one or more barbed structures in an underlying layer of matrix material.

24. The method of claim 14, further comprising extruding and depositing a final layer comprising a third matrix material, wherein any barbed structures protruding from any underlying layers are encapsulated by the final layer.

25. A three-dimensional object, comprising one or more barbed fibers disposed within a matrix material, wherein each barbed fiber comprises a central filament and one or more barbed structures extending outwardly from the central filament.
